(19) United States
(12) Patent Application Publication
(10) Pub. No.: US 2026/0326759 A1
(43) Pub. Date: Oct. 22, 2026

(54) DRIVING ASSISTANCE APPARATUS, DRIVING ASSISTANCE METHOD, AND NON-TRANSITORY COMPUTER-READABLE STORAGE MEDIUM

(71) Applicants: TOYOTA JIDOSHA KABUSHIKI KAISHA, Aichi (JP); DENSO CORPORATION, Aichi-pref. (JP)

(72) Inventor: Yuko YOSHIDA, Toyota-shi (JP)

(21) Appl. No.: 19/640,423

(22) Filed: Apr. 7, 2026

(30) Foreign Application Priority Data
Apr. 16, 2025 (JP) 2025-067290

(51) Int. Cl. B60W 30/14

(52) U.S. Cl. CPC B60W 30/146; B60W 2520/10; B60W 2520/28; B60W 2530/201; B60W 2552/30; B60W 2720/10

(57) ABSTRACT

A driving assistance apparatus executes vehicle speed control for causing a vehicle to travel such that a vehicle speed of the vehicle matches a target vehicle speed, and to terminate the vehicle speed control in response to the vehicle speed becoming equal to or less than an end speed. When a traveling area ahead of the vehicle is a predetermined target area in which it is necessary to change a traveling direction of the vehicle, the driving assistance apparatus acquires the target vehicle speed based on a shape of the target area. When a vehicle speed difference representing a difference between the target vehicle speed and the end speed is equal to or less than a threshold value, the driving assistance apparatus changes the target vehicle speed to a value of less than an original value of the target vehicle speed.

### TECHNICAL FIELD

The present disclosure relates to a driving assistance apparatus that executes vehicle speed control for causing a vehicle to travel such that a vehicle speed matches a target vehicle speed and terminates the vehicle speed control when the vehicle speed becomes equal to or lower than an end vehicle speed, a driving assistance method in which a computer mounted on a vehicle executes the vehicle speed control and terminates the vehicle speed control when the vehicle speed becomes equal to or lower than the end vehicle speed, and a non-transitory computer-readable storage medium storing a program for causing the computer to execute the vehicle speed control and to terminate the vehicle speed control when the vehicle speed becomes equal to or lower than the end vehicle speed.

### BACKGROUND

Conventionally, a driving assistance apparatus that executes vehicle speed control for causing a vehicle to travel such that a vehicle speed matches a target vehicle speed have been proposed. For example, a driving assistance apparatus described in Patent Document 1 (hereinafter referred to as a “conventional apparatus”) cancels (terminates) the vehicle speed control when the vehicle speed becomes an end vehicle speed (comparison vehicle speed).

Patent Document 1: Japanese Patent Application Laid-Open No. H09-076792

### SUMMARY

For example, when a travel area ahead of a vehicle is a target area (for example, a curve or a roundabout), a driving assistance apparatus acquires a target vehicle speed based on a shape of the target area and executes the vehicle speed control for causing the vehicle to travel such that the vehicle speed matches the target vehicle speed. Since the target vehicle speed is a value that varies depending on the shape of the target area, the target vehicle speed may be a value close to the end vehicle speed. Meanwhile, the vehicle speed acquired by the driving assistance apparatus may include an error due to factors such as air pressure of a tire and a friction coefficient of a road surface. When the target vehicle speed is close to the end vehicle speed, depending on conditions when the vehicle travels through the target area (such as the air pressure of the tire and road surface conditions), the vehicle speed may become equal to or lower than the end vehicle speed and the vehicle speed control may be terminated, or the vehicle speed may not become equal to or lower than the end vehicle speed and the vehicle speed control may continue without being terminated. The driver feels discomfort with respect to such vehicle speed control.

The present disclosure has been made in order to address the above-described problem. That is, one of the objects of the present disclosure is to provide a driving assistance apparatus capable of reducing a possibility that a situation when the vehicle travels in the target area affects termination or continuation of the vehicle speed control.

A driving assistance apparatus according to the present disclosure configures to execute vehicle speed control for causing a vehicle to travel such that a vehicle speed of the vehicle matches a target vehicle speed (step 435, step 425), and to terminate the vehicle speed control (step 440) in response to the vehicle speed becoming equal to or less than an end speed (“Yes” at step 410),

The driving assistance apparatus is configured to:
in response to a traveling area ahead of the vehicle being a predetermined target area in which it is necessary to change a traveling direction of the vehicle (“Yes” at step 315), acquire the target vehicle speed based on a shape of the target area (step 330); and
in response to a vehicle speed difference representing a difference between the target vehicle speed and the end speed being equal to or less than a threshold value (“Yes” at step 335), change the target vehicle speed to a value less than an original value of the target vehicle speed (step 340, step 340 shown in FIG. 5).

According to the driving assistance apparatus according to the present disclosure, the target vehicle speed is set to a value less than the original value of the target vehicle speed. Accordingly, even if an error occurs in the vehicle speed due to a change in a situation in which the vehicle VA travels in the traveling area, a possibility that the vehicle speed control is terminated can be increased. Therefore, a possibility that the situation in which the vehicle travels in the target area affects termination or continuation of the vehicle speed control can be reduced, and thus a possibility that a driver feels discomfort with respect to the vehicle speed control can be reduced.

### BRIEF DESCRIPTION OF THE DRAWINGS

FIG. 1 is a schematic system configuration diagram of a driving assistance apparatus according to an embodiment of the present disclosure.

FIG. 2 is a diagram for explaining an example of operation of the driving assistance apparatus according to the embodiment of the present disclosure.

FIG. 3 is a flowchart of an execution determination routine executed by a CPU of an ECU shown in FIG. 1.

FIG. 4 is a flowchart of a constant-speed control routine executed by the CPU of the ECU shown in FIG. 1.

FIG. 5 is a partial flowchart of the execution determination routine according to a modification of the embodiment of the present disclosure.

### DETAILED DESCRIPTION

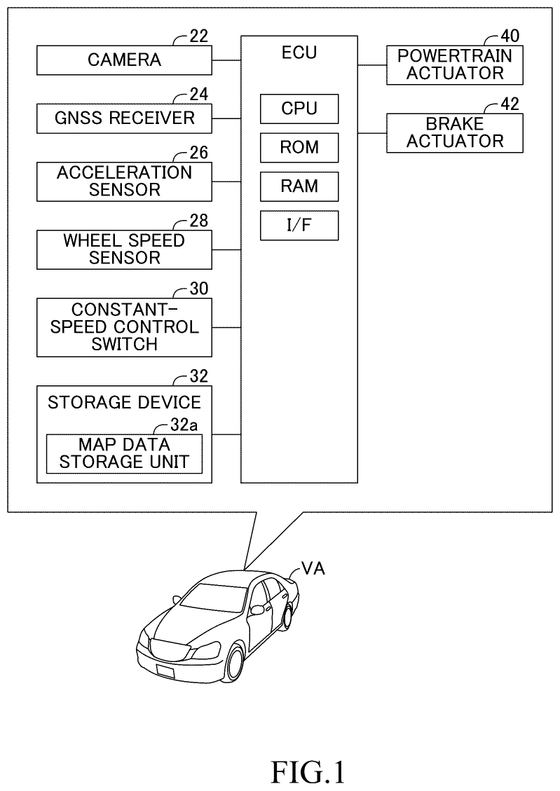

A driving assistance apparatus 10 according to an embodiment of the present disclosure (hereinafter also referred to as “the present apparatus 10”) is applied to a vehicle VA and includes the components shown in FIG. 1. In the present specification, an “ECU 20” is an electronic control unit having a microcomputer as a main component. The ECU 20 is also referred to as a control unit, a controller, or a computer. The microcomputer includes a CPU (processor), a ROM, a RAM, an interface (I/F), and the like. The functions realized by the ECU 20 may be realized by a plurality of ECUs.

A camera 22 acquires image data by capturing an image of a scene in front of the vehicle VA. The ECU 20 acquires the image data from the camera 22. A GNSS (Global Navigation Satellite System) receiver 24 receives signals from a plurality of artificial satellites and identifies a current position (latitude and longitude) of the vehicle VA based on the received signals. The ECU 20 acquires the current position of the vehicle VA from the GNSS receiver 24.

An acceleration sensor 26 measures an acceleration G of the vehicle VA in a longitudinal direction thereof. A wheel speed sensor 28 generates one pulse signal each time a wheel of the vehicle VA rotates by a predetermined angle. The ECU 20 counts the number of pulse signals generated by the wheel speed sensor 28 per unit time, and acquires a distance traveled by the vehicle VA per unit time based on the counted number of pulse signals. The ECU 20 acquires the distance as a vehicle speed Vs representing a speed of the vehicle VA. For example, the wheel speed sensor 28 generates one pulse signal each time the wheel rotates by 360°. In this case, the vehicle speed Vs is acquired based on the following Equation (1).

(1): Vs=2π×r×N . . . Equation (1).

r represents a radius of the wheel. N represents the number of pulse signals counted per unit time.

The wheel speed sensor 28 measures a rotational speed of the wheel, and the ECU 20 acquires, as the vehicle speed Vs, a circumferential length of the wheel rotating at the rotational speed.

The radius r of the wheel varies depending on an air pressure of a tire. Furthermore, even when the wheel makes one rotation, the vehicle VA does not necessarily travel a distance equal to the circumferential length (2π×r) of the wheel. In other words, the distance traveled by the vehicle VA per one rotation of the wheel varies depending on factors such as the friction coefficient of a road surface. Accordingly, an error occurs in the vehicle speed Vs.

A constant-speed control switch 30 is disposed in the vicinity of a steering wheel (not shown). When the constant-speed control switch 30 is operated while constant-speed control described later is not being executed, the ECU 20 executes the constant-speed control. On the other hand, when the constant-speed control switch 30 is operated while the constant-speed control is being executed, the ECU 20 terminates the constant-speed control.

A storage device 32 includes a map data storage unit 32a. The map data storage unit 32a stores map data in which positions (latitude and longitude) of curves and curvature C of the curves, and positions (latitude and longitude) of roundabouts and curvature C of the roundabouts, are registered.

A powertrain actuator 40 changes a driving force generated by a driving device (for example, an internal combustion engine and/or an electric motor) of the vehicle VA. A brake actuator 42 changes a braking force applied to the vehicle VA.

### Constant-speed Control

In the constant-speed control, the ECU 20 causes the vehicle VA to travel without driver operation so as to maintain the vehicle speed Vs at a preset set vehicle speed Vset. As an example, when the driver accelerates the vehicle VA to a desired vehicle speed Vs and then operates a setting switch (not shown), the ECU 20 sets the set vehicle speed Vset to the vehicle speed Vs.

### Area Travel Control

The ECU 20 executes area travel control when a start condition is satisfied during execution of the constant-speed control. Specifically, the ECU 20 determines that the start condition is satisfied when both the following Condition A1 and Condition A2 are satisfied.

Condition A1: A travel area ahead of the vehicle VA is a target area TA (a curve or a roundabout).

Condition A2: A distance D between the vehicle VA and an entrance of the target area TA is equal to or less than a start distance Dst.

When the start condition is satisfied, the ECU 20 acquires a target vehicle speed Vtgt based on a shape of the target area TA. Specifically, the ECU 20 acquires the target vehicle speed Vtgt that decreases as the curvature C increases. Since it is necessary to change a traveling direction of the vehicle VA more significantly as the curvature C increases, it is necessary to set the target vehicle speed Vtgt lower as the curvature C increases. In the area travel control, the ECU 20 decelerates the vehicle VA so that the vehicle speed Vs matches the target vehicle speed Vtgt when the vehicle VA reaches a point located a predetermined distance upstream of an entrance of the target area TA. Further, after the vehicle speed Vs matches the target vehicle speed Vtgt, the ECU 20 causes the vehicle VA to travel in the target area TA so as to maintain the vehicle speed Vs at the target vehicle speed Vtgt. The area travel control may also be referred to as “vehicle speed control.”

When the vehicle VA exits the target area TA, the ECU 20 terminates the area travel control. Thereafter, since the ECU 20 executes the constant-speed control, the ECU 20 accelerates the vehicle VA such that the vehicle speed Vs matches the set vehicle speed Vset.

When the vehicle speed Vs becomes equal to or less than an end vehicle speed Vend, the ECU 20 terminates the constant-speed control and the area travel control.

### Overview of Operation

When the ECU 20 acquires the target vehicle speed Vtgt, the ECU 20 determines whether or not a vehicle speed difference ΔV (=|Vtgt−Vend|) between the target vehicle speed Vtgt and the end vehicle speed Vend is equal to or less than a threshold ΔVth. When the vehicle speed difference ΔV is equal to or less than the threshold ΔVth, the CPU sets a new target vehicle speed Vtgt to “a value acquired by subtracting a predetermined value Vd from the target vehicle speed Vtgt (Vtgt−Vd).”

When an “original target vehicle speed Vtgt acquired based on the shape of the travel area” is close to the end vehicle speed Vend (that is, when the vehicle speed difference ΔV is equal to or less than the threshold ΔVth), the target vehicle speed Vtgt is set to a value less than the original target vehicle speed Vtgt. Each time the vehicle VA travels in the travel area, a situation when the vehicle VA travels in the travel area varies. Accordingly, an error may occur in the vehicle speed Vs acquired by the ECU 20 each time the vehicle VA travels in the travel area. Even if such an error occurs in the vehicle speed Vs, the ECU 20 can increase a possibility that the vehicle speed Vs becomes equal to or less than the end vehicle speed Vend during the area travel control and the area travel control is terminated as a result. Accordingly, it is possible to reduce a possibility that a situation when the vehicle VA travels in the target area TA affects termination or continuation of the area travel control, and thus to reduce a possibility that the driver feels discomfort with respect to the area travel control.

### Operation Example

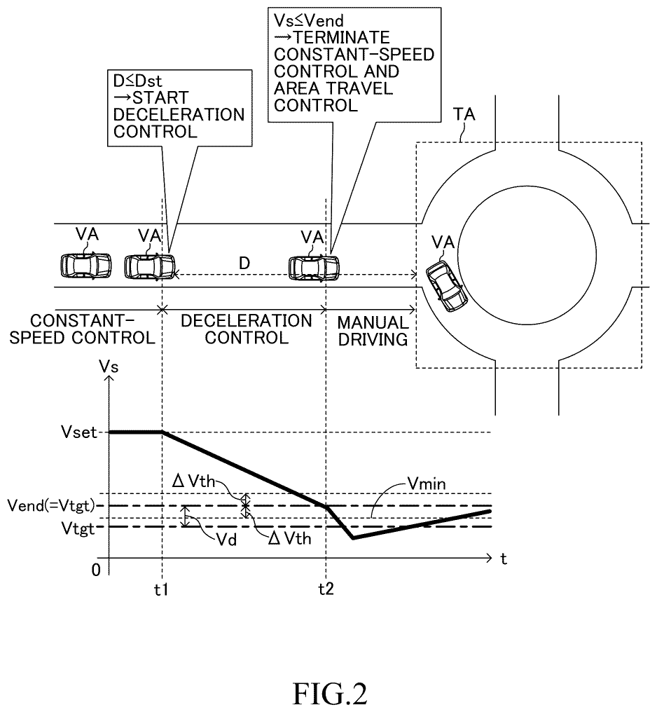

An operation example of the present apparatus 10 will be described with reference to FIG. 2.

Before time t1, the ECU 20 executes the constant-speed control, and the vehicle VA travels so as to maintain the vehicle speed Vs at the set vehicle speed Vset.

At time t1, both the condition A1 and the condition A2 are satisfied. The ECU 20 refers to the map data stored in the map data storage unit 32a and determines whether or not the target area TA exists in the traveling direction of the vehicle VA from the current position of the vehicle VA specified by the GNSS receiver 24 (that is, determines whether or not the condition A1 is satisfied). When the target area TA exists, the ECU 20 acquires the distance D based on the current position of the vehicle VA and a position of the target area TA. When the distance D is equal to or less than the start distance Dst, the ECU 20 determines that condition A2 is satisfied.

When both the condition A1 and the condition A2 are satisfied, the ECU 20 determines that the start condition is satisfied, and acquires the curvature C of the target area TA from the map data. The ECU 20 acquires the target vehicle speed Vtgt based on the curvature C. In the example shown in FIG. 2, it is assumed that the ECU 20 acquires the target vehicle speed Vtgt having the same value as the end vehicle speed Vend. Accordingly, the vehicle speed difference ΔV becomes “0,” and the vehicle speed difference ΔV is equal to or less than the threshold ΔVth. Therefore, the ECU 20 sets a new target vehicle speed Vtgt to “a subtraction value acquired by subtracting the predetermined value Vd from the target vehicle speed Vtgt.”

The predetermined value Vd is set such that the subtraction value becomes less than a lower limit value Vmin acquired by subtracting the threshold ΔVth from the end vehicle speed Vend. For example, it is assumed that the target vehicle speed Vtgt acquired based on the curvature C is “22 km/h,” the end vehicle speed Vend is “20 km/h,” and the threshold ΔVth is “3 km/h.” In this case, the lower limit value Vmin is “17 km/h (20 km/h−3 km/h),” and the predetermined value Vd is set to a value greater than a value obtained by subtracting the lower limit value Vmin from the target vehicle speed Vtgt (5 km/h=22 km/h−17 km/h). Accordingly, since the new target vehicle speed Vtgt becomes less than the lower limit value Vmin, it is possible to increase a possibility that the vehicle speed Vs becomes equal to or less than the end vehicle speed Vend during the area travel control and the area travel control is terminated, without being affected by the situation when the vehicle VA travels in the target area TA.

After time t1, the ECU 20 decelerates the vehicle VA so that the vehicle speed Vs matches the target vehicle speed Vtgt. At time t2, the vehicle speed Vs becomes equal to or less than the end vehicle speed Vend. In this case, the ECU 20 terminates the constant-speed control and the area travel control. After time t2, the driver causes the vehicle VA to travel by his or her own operation. Accordingly, the vehicle VA travels in the roundabout by manual driving.

### Specific Operation

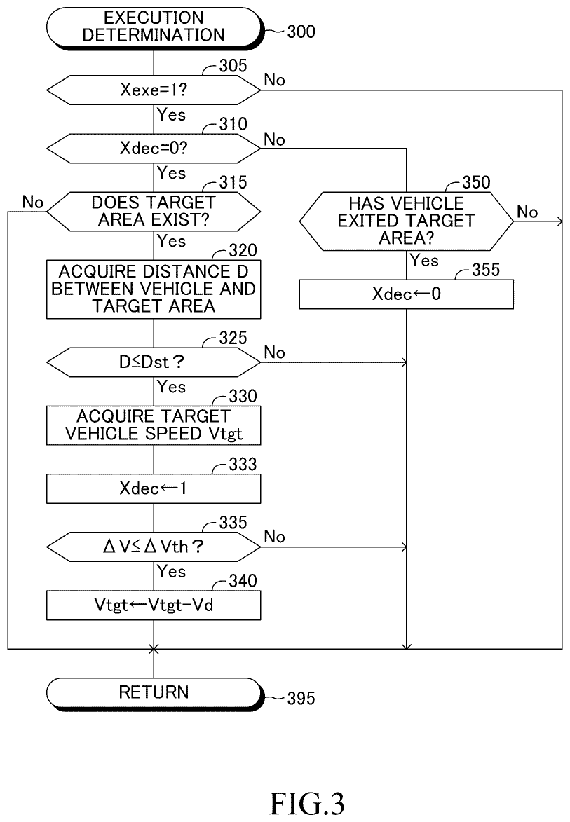

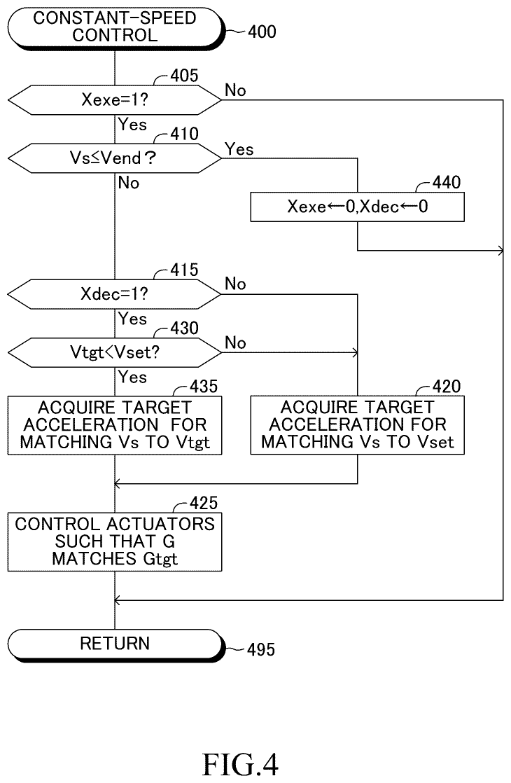

The CPU of the ECU 20 executes routines shown in flowcharts of FIGS. 3 and 4 each time a predetermined time period elapses.

### Execution Determination Routine

When an appropriate time comes, the CPU starts a process from step 300 of FIG. 3, and the process proceeds to step 305. At step 305, the CPU determines whether or not an execution flag Xexe is “1.” The execution flag Xexe is set to “1” when the constant-speed control is executed, and is set to “0” when the constant-speed control is not executed. The execution flag Xexe is set to “0” in an initialization routine. The initialization routine is executed by the CPU when an ignition key switch (not shown) of the vehicle VA is changed from an OFF position to an ON position.

When the execution flag Xexe is “0,” the CPU makes a “No” determination at step 305, and the process proceeds to step 395. At step 395, the CPU temporarily terminates the present routine.

When the execution flag Xexe is “1,” the CPU makes a “Yes” determination at step 305, and the process proceeds to step 310. At step 310, the CPU determines whether or not a travel control flag Xdec is “0.” The travel control flag Xdec is set to “1” when the area travel control is executed, and is set to “0” when the area travel control is not executed. The travel control flag Xdec is set to “0” in the initialization routine.

When the travel control flag Xdec is “0,” the CPU makes a “Yes” determination at step 310, and the process proceeds to step 315. At step 315, the CPU refers to map data around the current position of the vehicle VA and determines whether or not the target area TA exists ahead of the vehicle VA.

When the target area TA does not exist ahead of the vehicle VA, the condition A1 is not satisfied. In this case, the CPU makes a “No” determination at step 315, and the process proceeds to step 395.

On the other hand, when the target area TA exists ahead of the vehicle VA, the condition A1 is satisfied. In this case, the CPU makes a “Yes” determination at step 315 and executes steps 320 and 325.

Step 320: The CPU refers to the map data and acquires the distance D between the vehicle VA and the target area TA existing ahead of the vehicle VA.

Step 325: The CPU determines whether or not the distance D is equal to or less than the start distance Dst.

When the distance D is greater than the start distance Dst, the condition A2 is not satisfied. In this case, the CPU makes a “No” determination at step 325, and the process proceeds to step 395. On the other hand, when the distance D is equal to or less than the start distance Dst, the condition A2 is satisfied and the start condition is satisfied. In this case, the CPU makes a “Yes” determination at step 325 and executes steps 330 to 335.

Step 330: the CPU Acquires the target vehicle speed Vtgt based on the curvature C of the target area TA.

Step 333: The CPU sets the travel control flag Xdec to “1.”

Step 335: The CPU determines whether or not the vehicle speed difference ΔV between the target vehicle speed Vtgt and the end vehicle speed Vend is equal to or less than the threshold ΔVth.

When the vehicle speed difference ΔV is equal to or less than the threshold ΔVth, the CPU makes a “Yes” determination at step 335, and the process proceeds to step 340.

At step 340, the CPU sets the new target vehicle speed Vtgt to the subtraction value acquired by subtracting the predetermined value Vd from the target vehicle speed Vtgt acquired at step 330.

The CPU sets the predetermined value Vd to a value greater than a value acquired by subtracting the lower limit value Vmin (acquired by subtracting the threshold ΔVth from the end vehicle speed Vend) from the target vehicle speed Vtgt acquired at step 330. As a result, the new target vehicle speed Vtgt becomes less than the lower limit value Vmin. Thereafter, the process proceeds to step 395.

On the other hand, when the vehicle speed difference ΔV is greater than the threshold ΔVth, the CPU makes a “No” determination at step 335, and the process proceeds to step 395.

When the travel control flag Xdec is “1” when the process proceeds to step 310, the CPU makes a “Yes” determination at step 310, and the process proceeds to step 350. At step 350, the CPU refers to map data around the current position of the vehicle VA and determines whether or not the vehicle VA has exited the target area TA.

When the vehicle VA has not exited the target area TA, the CPU makes a “No” determination at step 350, and the process proceeds to step 395. On the other hand, when the vehicle VA has exited the target area TA, the CPU makes a “Yes” determination at step 350, and the process proceeds to step 355. At step 355, the CPU sets the travel control flag Xdec to “0.” Thereafter, the process proceeds to step 395.

### Constant-Speed Control Routine

When an appropriate time comes, the CPU starts a process from step 400 of FIG. 4, and the process proceeds to step 405. At step 405, the CPU determines whether or not the execution flag Xexe is “1.”

When the execution flag Xexe is “0,” the CPU makes a “No” determination at step 405, and the process proceeds to step 495. At step 495, the CPU temporarily terminates the present routine.

When the execution flag Xexe is “1,” the CPU makes a “Yes” determination at step 405, and the process proceeds to step 410. At step 410, the CPU determines whether or not the vehicle speed Vs is equal to or less than the end vehicle speed Vend.

When the vehicle speed Vs is greater than the end vehicle speed Vend, the CPU makes a “No” determination at step 410, and the process proceeds to step 415. At step 415, the CPU determines whether or not the travel control flag Xdec is “1.”

When the travel control flag Xdec is “0,” the CPU makes a “No” determination at step 415 and executes steps 420 and 425.

Step 420: The CPU acquires a target acceleration Gtgt for causing the vehicle speed Vs to match the set vehicle speed Vset.

Step 425: The CPU controls the powertrain actuator 50 and the brake actuator 52 such that the acceleration G matches the target acceleration Gtgt.

Thereafter, the process proceeds to step 495.

When the travel control flag Xdec is “1” when the process proceeds to step 415, the CPU makes a “Yes” determination at step 415, and the process proceeds to step 430. At step 430, the CPU determines whether or not the target vehicle speed Vtgt is less than the set vehicle speed Vset. Normally, the target vehicle speed Vtgt is less than the set vehicle speed Vset.

When the target vehicle speed Vtgt is less than the set vehicle speed Vset, the CPU makes a “Yes” determination at step 430, and the process proceeds to step 435. At step 435, the CPU acquires the target acceleration Gtgt for causing the vehicle speed Vs to match the target vehicle speed Vtgt. Thereafter, the process proceeds to step 425, and the CPU controls the powertrain actuator 50 and the brake actuator 52.

When the target vehicle speed Vtgt is equal to or greater than the set vehicle speed Vset, the CPU makes a “No” determination at step 430, and the process proceeds to step 420. When the set vehicle speed Vset is set to a small value, the target vehicle speed Vtgt may be equal to or greater than the set vehicle speed Vset. In this case, if the vehicle VA starts accelerating when approaching the target area TA, there is a high possibility that the driver may feel discomfort. Therefore, in the present embodiment, even when the target vehicle speed Vtgt is equal to or greater than the set vehicle speed Vset, the vehicle VA is caused to travel such that the vehicle speed Vs matches the set vehicle speed Vset.

When the vehicle speed Vs is equal to or less than the end vehicle speed Vend when the process proceeds to step 410, the CPU makes a “Yes” determination at step 410, and the process proceeds to step 440. At step 440, the CPU sets the execution flag Xexe and the travel control flag Xdec to “0.” Thereafter, the process proceeds to step 495.

As described above, when the vehicle speed difference ΔV is equal to or less than the threshold ΔVth, the ECU 20 reduces the target vehicle speed Vtgt. Accordingly, even if an error occurs in the vehicle speed Vs, the ECU 20 can increase a possibility that the area travel control is terminated. Therefore, it is possible to reduce a possibility that a situation when the vehicle VA travels in the target area TA affects termination or continuation of the area travel control, and thus to reduce a possibility that the driver feels discomfort with respect to the area travel control.

Further, when the vehicle speed difference ΔV is equal to or less than the threshold ΔVth, the ECU 20 sets the target vehicle speed Vtgt to be less than the lower limit value Vmin acquired by subtracting the threshold ΔVth from the end vehicle speed Vend. Accordingly, it is possible to increase a possibility that the vehicle speed Vs becomes equal to or less than the end vehicle speed Vend during the area travel control and the area travel control is terminated, without being affected by a situation when the vehicle VA travels in the target area TA.

The present disclosure is not limited to the above-described embodiment, and various modifications of the present disclosure may be adopted.

In the above embodiment, the ECU 20 determines whether or not the target area TA exists ahead of the vehicle VA based on the map data. However, the ECU 20 may determine whether or not the target area TA exists ahead of the vehicle VA based on the image data. Specifically, the ECU 20 identifies lane markings (for example, white lines) of a travel area in which the vehicle VA travels, based on the image data. The ECU 20 then acquires a curvature of the lane markings based on the image data, and determines that the target area TA exists ahead of the vehicle VA when the curvature is equal to or greater than a threshold curvature and the same curvature is acquired over a predetermined distance. The ECU 20 acquires the target vehicle speed Vtgt based on the same curvature acquired over the predetermined distance.

For example, when a manufacturer of the wheel speed sensor 28 or the like clarifies an error range of the vehicle speed Vs acquired using the wheel speed sensor 28, the threshold ΔVth is set based on the error range of the wheel speed sensor 28. For example, the threshold ΔVth is set to a larger one of a positive-side error and a negative-side error of the wheel speed sensor 28.

In the above embodiment, when the vehicle speed difference ΔV is equal to or less than the threshold ΔVth, the ECU 20 decreases the target vehicle speed Vtgt by the predetermined value Vd. However, the target vehicle speed Vtgt may be increased by the predetermined value Vd. Accordingly, it is possible to increase a possibility that the area travel control is continued, and to reduce a possibility that the driver feels discomfort with respect to the area travel control.

Further, when the vehicle speed difference ΔV is equal to or less than the threshold ΔVth and the target vehicle speed Vtgt is equal to or less than the end vehicle speed Vend, the ECU 20 may decrease the target vehicle speed Vtgt by the predetermined value Vd as in the above embodiment. When the vehicle speed difference ΔV is equal to or less than the threshold ΔVth and the target vehicle speed Vtgt is greater than the end vehicle speed Vend, the ECU 20 may increase the target vehicle speed Vtgt by a predetermined value Vd'. It is thereby possible to increase a possibility that the area travel control is continued while reducing a possibility that the vehicle VA enters the target area TA at the vehicle speed Vs higher than the original target vehicle speed Vtgt.

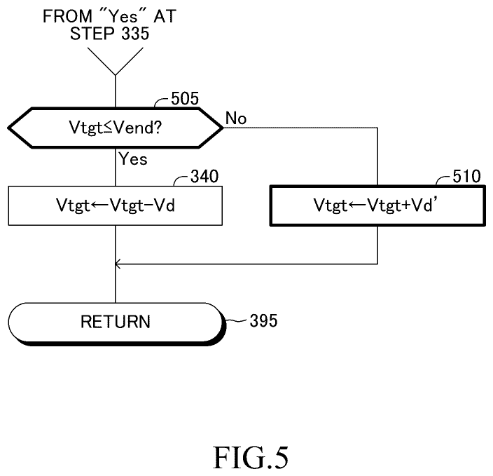

Specifically, when the CPU makes a “Yes” determination at step 335 shown in FIG. 3 (that is, when the vehicle speed difference ΔV is equal to or less than the threshold ΔVth), the process proceeds to step 505 shown in FIG. 5. At step 505, the CPU determines whether or not the target vehicle speed Vtgt is equal to or less than the end vehicle speed Vend.

When the target vehicle speed Vtgt is equal to or less than the end vehicle speed Vend, the CPU makes a “Yes” determination at step 505 and sets the new target vehicle speed Vtgt to the subtraction value acquired by subtracting the predetermined value Vd from the target vehicle speed Vtgt at step 340 shown in FIG. 5. Thereafter, the process proceeds to step 395 shown in FIG. 5.

On the other hand, when the target vehicle speed Vtgt is greater than the end vehicle speed Vend, the CPU makes a “No” determination at step 505 and, at step 510, sets the new target vehicle speed Vtgt to an addition value acquired by adding the predetermined value Vd′ to the target vehicle speed Vtgt. The predetermined value Vd′ is set to a value greater than a value acquired by subtracting the target vehicle speed Vtgt acquired at step 330 from an upper limit value Vmax acquired by adding the threshold ΔVth to the end vehicle speed Vend. Accordingly, the new target vehicle speed Vtgt becomes greater than the upper limit value Vmax. Thereafter, the process proceeds to step 395 shown in FIG. 5.

The target area TA may be any travel area in which a change in the traveling direction of the vehicle VA is required, and is not limited to the curve or the roundabout.

The present disclosure may also be regarded as a non-transitory computer-readable storage medium storing a program for realizing the functions of the present apparatus 10. Further, the present apparatus 10 is also applicable to an autonomous vehicle.

What is claimed is:

1. A driving assistance apparatus configured to execute vehicle speed control for causing a vehicle to travel such that a vehicle speed of the vehicle matches a target vehicle speed, and to terminate the vehicle speed control in response to the vehicle speed becoming equal to or less than an end speed,
wherein the driving assistance apparatus is configured to:
in response to a traveling area ahead of the vehicle being a predetermined target area in which it is necessary to change a traveling direction of the vehicle, acquire the target vehicle speed based on a shape of the target area; and
in response to a vehicle speed difference representing a difference between the target vehicle speed and the end speed being equal to or less than a threshold value, change the target vehicle speed to a value less than an original value of the target vehicle speed.

2. The driving assistance apparatus according to claim 1,
wherein the driving assistance apparatus is configured to,
in response to the vehicle speed difference being equal to or less than the threshold value, change the target vehicle speed so that the target vehicle speed becomes less than a lower limit value acquired by subtracting the threshold value from the end speed.

3. The driving assistance apparatus according to claim 2,
wherein the target area is a curve or a roundabout,
wherein the driving assistance apparatus:
comprises a wheel speed sensor configured to measure a rotational speed of a wheel;
acquires the vehicle speed based on a circumferential length of the wheel rotated at the rotational speed;
acquires the target vehicle speed that decreases as a curvature of the target area increases;
in response to the vehicle speed difference being equal to or less than the threshold value and the target vehicle speed being greater than the end speed, changes the target vehicle speed so that the target vehicle speed becomes greater than an upper limit value acquired by adding the threshold value to the end speed; and
in response to the vehicle speed difference being equal to or less than the threshold value and the target vehicle speed being equal to or less than the end speed, changes the target vehicle speed so that the target vehicle speed becomes less than the lower limit value.

4. A driving assistance method executed by a computer mounted on a vehicle, the driving assistance method comprising:
executing vehicle speed control for causing the vehicle to travel such that a vehicle speed of the vehicle matches a target vehicle speed, and terminating the vehicle speed control in response to the vehicle speed becoming equal to or less than an end speed;
in response to a traveling area ahead of the vehicle being a predetermined target area in which it is necessary to change a traveling direction of the vehicle, acquiring the target vehicle speed based on a shape of the target area; and
in response to a vehicle speed difference representing a difference between the target vehicle speed and the end speed being equal to or less than a threshold value, changing the target vehicle speed to a value less than an original value of the target vehicle speed.

5. A non-transitory computer-readable storage medium storing a program for causing a computer mounted on a vehicle to:
execute vehicle speed control for causing the vehicle to travel such that a vehicle speed of the vehicle matches a target vehicle speed, and terminate the vehicle speed control in response to the vehicle speed becoming equal to or less than an end speed;
in response to a traveling area ahead of the vehicle being a predetermined target area in which it is necessary to change a traveling direction of the vehicle, acquire the target vehicle speed based on a shape of the target area; and
in response to a vehicle speed difference representing a difference between the target vehicle speed and the end speed being equal to or less than a threshold value, change the target vehicle speed to a value less than an original value of the target vehicle speed.
